(19) United States
(12) Patent Application Publication
(10) Pub. No.: US 2005/0038993 A1
(43) Pub. Date: Feb. 17, 2005

(54) Information security model

(76) Inventors: Predrag Zivic, Toronto (CA); Jovan Miladinovic, Toronto (CA); Slavoljub Pavlovic, Toronto (CA)

Correspondence Address: Mark B Eisen;Dimock Stratton, Suite 3202 Box 102, 20 Queen Street West, Toronto, M5H 3R3, CA

(21) Appl. No.: 10/482,274

(22) PCT Filed: Jun. 26, 2002
(86) PCT No.: PCT/CA02/00958

(30) Foreign Application Priority Data
Jun. 26, 2001 (CA) 2,351,898

(51) Int. Cl. H04L 9/00

(52) U.S. Cl. 713/164

(57) ABSTRACT

An information security model provides a set of schemas that ensure coverage of all securing components. All points are addressed and evaluated in a net of three-dimensional coorindate knots The model defines the relation between components in the information risk and security space, and provides an information risk and security framework that ensures that all information security components are addressed; enables standardized information security audit; provides information risk compliance numbers; and defines strategic business direction to address information security implementation. The information security model of the present invention standardizes the approach and creates a matrix through which risk compliance factors can be calculated.

### FIELD OF INVENTION

This invention relates to information security. In particular, this invention relates to a method for augmenting risk and security strategy and workflow models with security concepts and measures using simple, understandable, and straightforward model

### BACKGROUND OF THE INVENTION

The Information Security Model describes business based approach/methodology data structures that are used to analyze and measure risk and security related impacts on business processes in modern enterprise.

The objective of the Information Security Model is to define a standardized set of structures that can be used to exchange data between different risk and security management systems. These structures provide the basis for standardized data bindings that allow exact industry information security compliancy level quantifications.

The following specification is focused on defining interoperability between systems residing within the same enterprise or organization and their compliancy presentation within the specific industry best practices and industry vertical average.

Traditionally, computer security is often something that is not an integral part of business management system. It is in practice more often than not the case that “security” is limited to periodical backups and whatever access controls are present in the operating system. When entering into a society where possession of information and the ability to process are becoming strategic resources that can be vital to the survival of an organization a broad and coordinated view on information security becomes paramount. At the same time as information becomes increasingly important, advances in communication technology make it possible to build software systems that are highly distributed. While providing many new possibilities, there are also many security issues tied to the use distributed systems.

The motivation to create information security model is to help business people to understand information risk and security challenges and to enable information security professionals create easy and complete strategy for information protection.

This framework is intended to contribute to the knowledge necessary for making the transition to a new view on security that both place security issues as an integral part of the business activities within an organization and that also take into account the problems arising through the use of distributed technology.

The aim of the present invention is to provide a way to model an organization that can monitor, measure and define strategic activities that should tale place within the organization. It should also be possible to model how information flows and is processed within the organization.

A key goal is to augment risk and security strategy and wordflow models with security concepts and measures using simple, understandable, and straightforward model.

### BACKGROUND OF THE INVENTION

Information technology departments have mystified the information security. After the centralized mainframe and security issues solved on the mainframe platform, distributed computing added enormous amount of new challenges. The information technology professionals could not come up with the information security model that could solve all distributed computing problems.

There are a lot of different approaches to information security. Not a single approach covers the complete information risk and security field. The information security model of the present invention was developed to help provide information risk and security solutions, and information security audits.

### SUMMARY OF THE INVENTION

This model was developed to provide an information risk and security framework that enforces the following:
Ensure that all information security components are addressed
Enable standardized information security audit
Provide information risk compliance numbers
Define strategic business direction to address information security implementation

The information security model of the present invention standardizes the approach and creates a matrix through which risk compliance factors can be calculated. The information security model serves as a model, framework and template through which complete standardized and measurable information security and risk analysis are developed.

The present invention thus provides a method of increasing security in an organization, comprising the steps of: a. defining a plurality of information technology entities; b. defining a plurality of risk and/or security components; c. defining a plurality of security functional components; and d. calculating a level of compliance of the organization's security components relative to a selected level of compliance.

The present invention further provides method of increasing security in an organization, comprising the steps of: a. defining a plurality of information technology entities; b. defining a plurality of risk and/or security components; c. defining a plurality of security functional components; and d. calculating a level of risk of the organization's security components relative to a selected level of risk.

### BRIEF DESCRIPTION OF THE DRAWINGS

In drawings which illustrate a preferred embodiment of the invention by way of example only,

FIG. 1 is a schematic representation of the information security model.

### DETAILED DESCRIPTION OF THE INVENTION

The information security model encompasses integration of information infrastructure components, business processes and procedures and defines information value. All components are used to calculate information risk compliance and define security implementation strategy.

The model is multi-dimensional. However for the simplicity reasons, it is presented as an information security model cube for illustrative purposes.

The information security model provides a set of schemas that ensure coverage of all security components. The few examples of the three-dimensional coordinate knots could be:
Network-Authentication-Confidentiality
Network Authentication-Integrity
Network-Access Control-Availability
Etc.

All the points are addressed and evaluated. Once the whole net of knots mentioned above is covered, the information security model insures that all security components are covered. At the same time the information security model stands even when some components are not considered. The information security model can address only Authentication across IT components and security attributes. It is important to understand that the model defines the relation between components in the information risk and security space.

The network could be represented through the combination of schemas for every single infrastructure component.

Physical Layer—Access to Operation Premises

| | | | | AUDIT/ | | |
|---|---|---|---|---|---|---|
| | | ACCESS | | TRAIL | INFOSEC. | |
| | AUTHENTICATION | CONTROL | DP & CI | LOG | MGMT | BRP |
| Confidentiality | | | | | | |
| Integrity | | | | | | |
| Availability | | | | | | |
| Accountability/non- | | | | | | |
| repudiation | | | | | | |
| Privacy | | | | | | |

This specific schema repeats for every single infrastructure component such as network, system, data and application.

Once assessed, the information is calculated relative to the baseline data for industry average and industry best practices (such as NIST, CSE, ISO & IEC), and entered into the table.

Once the value for each field is calculated, the factor of business process and information value adds to the compliance equation.

Information Policy

There are many “definitions” of information policy. Mostly all of the definitions are dependent upon how one defines information. According to Weingarten, information policy is “the set of all public laws, regulations, and policies that encourage, discourage, or regulate the creation, use, storage, and communication of information.” (1989) Rowlands summarizes the many views of information policy to define their common characteristics. Using Weingarten's view, Rowlands suggests, “that the fundamental role of policy is to provide the legal and institutional frameworks within which formal information exchange can take place.” (1996, p. 14) Rowlands concludes by offering a three-level hierarchical model for information policy:
Infrastructure policies that apply across society and affect the information sector both directly and indirectly;
Horizontal information policies which apply to the entire information sector for particular applications such as export-control policies or data protection law; and
Vertical information policies that apply to a specific part of the information sector for a particular application.

An efficient computer security policy has to ensure that efforts spent on security yield cost effective benefits. Although this may seem obvious, it is possible to be misleading about where the effort is needed. As an example, there is a great deal of publicity about intruders on computers systems; yet most surveys of computer security show that, for most organizations, the actual loss from “insiders” is much greater.

Risk analysis involves determining what one needs to protect, what one needs to protect it from, and how to protect it. It is the process of examining all of one's risks, then ranking those risks by level of severity. This process involves making cost-effective decisions on what one wants to protect. As mentioned above, information security model provides for quick inventory of components to be addressed and helps to define why one should probably not spend more to protect something than it is actually worth.

The most important element of risk analysis is to identify the information assets using the information technology entities provide by the information security model. Therefore ensuring that none of the information assets was missed. The basic goal is to provide information asset availability, confidentiality, accountability/non repudiation, privacy and integrity.

To create risk management process, risk analysis should be performed on a periodic basis and security implementation should be measured using standardized information security model approach.

Information Confidentiality Definition

Information of different types needs to be secured in different ways. Therefore a classification system is needed, whereby information is classified, a policy is laid down on how to handle information according to its class and security mechanisms are enforced on systems handling information accordingly.

1. Public/Non Classified Information

Description: Data on these systems could be made public without any implications for the company (i.e. the data is not confidential). Data integrity is not vital. Loss of service due to malicious attacks is an acceptable danger. Examples: Test services without confidential data, certain public information services.

2. Internal Information

Description: External access to this data is to be prevented, but should this data become public, the consequences are not critical (e.g. the company may be publicly embarrassed). Internal access is selective. Data integrity is important but not vital. Examples of this type of data are found in development groups (where no live data is present), certain production public services, certain Customer Data, “normal” working documents and project/meeting protocols and internal telephone books.

3. Confidential Information

Description: Data in this class is confidential within the company and protected from external access. If such data were to be accessed by unauthorized persons, it could influence the company's operational effectiveness, cause an important financial loss, provide a significant gain to a competitor or cause a major drop in customer confidence. Data integrity is vital. Examples: Salaries, Personnel data, Accounting data, very confidential customer data, sensitive projects and confidential contracts. Data centers normally maintain this level of security.

4. Secret Information

Description: Unauthorized external or internal access to this data could be critical to the company. Data integrity is vital. The number of people with access to this data should be very small. Very strict rules must be adhered to in the usage of this data. Examples: information about major pending contracts/reorganization/financial transactions.

Adherence to Corporate and Legislative Requirements

The local, national and international laws (e.g. on data privacy, dissemination of pornography) must be adhered to.

The integral part of confidentiality information classification is a procedure that defines the information classification process. Trivial example: All documents should be classified and the classification level should be written on at least the title page.

Information Value

The sole purpose of the enterprise security management infrastructure is to serve business needs. Therefore, a successful information security policy has to be driven by corporate business structures. The following basic concepts are the minimum baseline for the information value determination process:
All major information assets shall have an owner.
The data or process owner must classify the information into one of the security levels depending on legal obligations, costs, corporate policy and business needs.
The owner is responsible for this data and must secure it or have it secured (e.g. via a security administrator) according to its classification.

Once the information asset owners have been identified and data classified, the following parameters will determine the information value:
Intellectual property value,
Marketing and sales strategy value,
Confidentiality level,
Corporate image perception after successful intrusion.

By following this approach the information owner will establish the information value. The information value level will be used by information security group to define the appropriate set of security tools to protect the data.

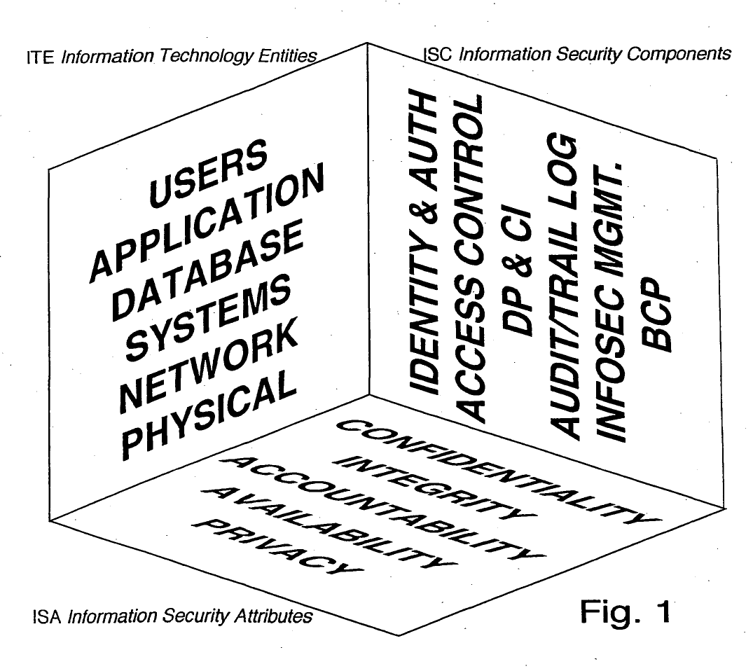

The high level, 3-D presentation of the model illustrated in FIG. 1 has some basic logical similarities with OSI model. The model identifies the security components together with their functions or attributes, applied against recognized information resources.

It is important to understand that information security model can either encompass all components or address only specific components within the given axis such as addressing only network resources against two other axes. The information security model defines relations between components that are forming a knot in the information security space network. Thus the model stands even if only some components are used for analysis. The most complete information protection picture for a company will be obtained if all information security model components are used. However it is allowed and recommended, due to a large number of knots, to address specific components required for risk or security analysis.

Axis 1—Information Technology Entities

Users
The most important information technology and information asset entity are users. As an information technology entity, users interact with other information technology entities and specifically require application of security controls. Category of users can be divided into corporate (internal users), business partner users, clients and public users. According to it category, specific security components and security attributes will be applied.
Application
This general category assumes all end user and infrastructure applications. Applications rely on other information technology entities and should not be isolated. Application entity layer can be divided into web based applications, windows applications or sub-entities could be created according to the application functionality such as billing, resource planning, sales automation and other types of applications.
Database
Database presents the information stored and transferred through information infrastructure. This category includes database engines such as Relation DataBase Management System, Object Oriented DataBase Management System as well as data transfer from users through applications to data stores. This level is solely dedicated to data architecture, distribution in relation with other information technology entities.
Systems
This category refers to the systems software and the steps used in their development and maintenance.
Network
Two or more systems connected by a communications medium, where components attached to it are responsible for the transfer of information. Such components may include automated information systems, packet switches, telecommunication controllers, distribution centers, technical management, and control devices.
Physical
The physical domain addresses the threats, vulnerabilities, and countermeasures that can be utilized to physically protect an enterprise's resources and sensitive information. These resources include people, the facility in which they work, and the data, equipment, support systems, media, and supplies they utilize.
   Axis 2—Security Components
Identification and Authentication.
Identification and authentication is the act of identifying or verifying the eligibility of an information technology entity to access specific categories of information. It is providing assurance regarding the identity of a subject or object, for example, ensuring that a particular information technology entity is who that entity claims to be. It also ensures that information technology entity passes or holds the authentication mechanism to be able to provide it at requested times to other security components.
Access Control
Access control is the process of limiting access to the information technology resources only to resources that the authenticated information technology entity is entitled to. Synonymous with controlled access and limited access. This is a preventive and technical control to ensure proper access to information technology resources by authenticated information technology entities. Access control presents a foundation for the sound information security policy and proper implementation of information security controls.
Data Protection & Content Inspection
Physical, administrative, personnel, and technical security measures which, when applied separately or in combination, are designed to reduce the probability of harm, loss, damage to, or compromise of data. Therefore, information technology entities should have controls applied to decrease the probability of harm, loss damage to or compromise of information.
Audit/Log Trail
Established procedures of recording, reviewing, correlation and examination of system records and activities to test for adequacy of system controls. All information technology entities and security components generate the log information. Strategies on how to collect, analyze, correlate information in consolidated log information is important part of any establishment of security controls and risk analysis.
Information Security Management System
Established methodology and procedures in collection, processing, maintenance, transmission and dissemination of risk analysis and security information in accordance with defined procedures, whether automated or manual is part of the information security management system. All security components and information technology entities must be managed for security.
Business Continuity Planning
Technical and corrective control mechanism necessary to restore a system's computational and processing capability and data files after a system failure or penetration
   Axis 3—Security Functional Components
Confidentiality
Ensuring that the information is disclosed, according to the information value, only to authorized information technology entities (e.g., individuals, processes). Confidentiality pertains to the process and security controls to provide for controlled access to a specific information value.
Integrity
The state achieved by maintaining and authenticating the accuracy and accountability of information technology entities and security components.

To ensure that the correct information is passed between entities and security components, integrity is used to ensure correctness and accuracy.
Availability
The state that exists when automated services or system data can be obtained within an acceptable period at a level and in the form the system user wants. Any component of the information security model must be available to the user within the period agreed on within the service level or entity acceptable period of time.
Accountability/Non Repudiation
A mechanism that with high assurance can be asserted to be genuine, and that cannot subsequently be refuted. It is the security service by which the entities involved in communication cannot deny having participated.
Privacy
A mechanism that with high assurance can be asserted to provide for a protection from disclosure or unauthorized use of personal information.

All entities and components can be divided into smaller sub-entities or subcomponents. These sub-entities are driven and developed by the information security model user and the model will still stand as it relates components and defines the information security space. The information security model allows for these divisions to help information security model users model the information risk and security according to their own environments and corporate business process. The information security model defines a baseline on top of which every information security model user can build to obtain proper and custom tailored risk and security analysis.

Compliance Baselining

The Information Security Model addresses two levels of compliance metrics: industry best practices and industry average compliance. The industry best practices can be described as a state where all security components reach near ideal status relative to the best software tools and methods available on the market (always less than 100% of the ideal state). This is highly dynamic system, dependent on the ongoing development of the security tools and methodologies.

The industry average compliance base lining is highly dependent on an ongoing audit mechanism. The information today is gathered using existing organization security audit documents or audits performed by the inventors.

The best practices data is readily available from different sources such as international standards, government and non-government agencies (commercial sources). Standards such as ISO 17799/BS7799, Common Criteria, CSI, CIS, NIST, SANS.

The absolute accuracy of the baselines (hard to achieve) is not the ultimate goal of the Information Security Model. This quality is superseded by the consistency of the compliance quantification process. The ISM aims to provide an organizational tool that facilitates near real-time monitoring and relative quantification of the security levels. It also allows for security components modeling and quantified strategy.

Calculating the Compliance

To present the process of calculating the levels of compliance we will use a subset of one of the IT resources as identified in ISM (Axis 1)—ISDN Services as a subset of Network.

The first step is to collect the audit data and transpose it to the compliancy values percentages) using the principles presented in the following sections:
The calculation process includes steps that must be done in order
Define the information value (see information value chapter)
Define information value zones
Define user groups—entities used to calculate compliance for.

The following table explains the relevance of the functional components of ISDN authentication for calculating the compliance levels:

TABLE 1
ISDN - Authentication functional components

| | | | | ACCOUNTABILITY/ |
|---|---|---|---|---|
| ISDN | CONFIDENTIALITY | INTEGRITY | AVAILABILITY | NONREPUDIATION |
| AUTHENTICATION | End-to-end | ICV encryption | Redundant lines | Notary mechanism- |
| | encryption | level | | trusted third |
| | Physical | Sequence number | | party |
| | protection of | fields within the | | |
| | the entire | range of ICV | | |
| | network | | | |
| | Secure routing | | | |

Formulas to calculate the levels of compliance for a user group per information value zone:
Authentication type coefficient (AT) for security functional components
Number of access points (NAP)
Number of authenticated access points (NAAP)
Compliance=(NAAP*AT)/NAP

To this formula we could add the value for the specific information value zone and the business process followed by the user group, but the model flexibility enables users and their respective organizations to follow internal policy and add internal calculations. An organization and an information security model user can decide to use different formula adapted to the information security model user process and usage of different ISO17799 risk and security standard baselines. Therefore this is one model suggested calculation, but due to relation between model components, information security model user can choose different formula to calculate a level of compliance for the specific knot in the information security space defined by the model and according to the desired standard.

Access Control

There are three principal access control concerns for ISDN security:
Network access (long distance, international, secure call, PBX)
Terminal/telephone access (inward and outward)

Access to network databases (records of calls, routing and management databases)

TABLE 2
ISDN - Access Control functional components

| | | | | ACCOUNTABILITY/ |
|---|---|---|---|---|
| ISDN | CONFIDENTIALITY | INTEGRITY | AVAILABILITY | NONREPUDIATION |
| ACCESS | Network | Control of the | Access through | Level of |
| CONTROL | databases | access privileges | redundant lines | dependency |
| | accessible only | | | between |
| | to the security | | | identification |
| | management | | | (authentication) |
| | | | | and privileges |

TABLE 3
Audit Trail

| | | | | ACCOUNTABILITY/ |
|---|---|---|---|---|
| ISDN | CONFIDENTIALITY | INTEGRITY | AVAILABILITY | NONREPUDIATION |
| AUDIT | Audit trace and | Repeatable audit | Audit trace | Audit trace |
| | reports | trace and | archiving and | procedures must |
| | available to the | procedures. | availability of | provide for audit |
| | security | Consistency. | historical audits | log consistency |
| | management | | data | and non- |
| | only. | | | repudiation. |

TABLE 4
Information Security Management

| | | | | ACCOUNTABILITY/ |
|---|---|---|---|---|
| ISDN | CONFIDENTIALITY | INTEGRITY | AVAILABILITY | NONREPUDIATION |
| ISM | Management | Management | Security | Management tools |
| (Risk, policy, | procedure and | tools and | management tools | actions must |
| user) | tools available | procedures must | availability is | provide for |
| | only to | ensure that | crucial to securing | accountability and |
| | infrastructure | infrastructure | the enterprise | non-repudiation or |
| | management | changes are | infrastructure. | must integrate |
| | teams. | performed only | | with the existing |
| | | with the defined | | non-repudiation |
| | | set of tools. | | infrastructure. |

TABLE 5
Business Continuity Planning

| | | | | ACCOUNTABILITY/ |
|---|---|---|---|---|
| ISDN | CONFIDENTIALITY | INTEGRITY | AVAILABILITY | NONREPUDIATION |
| BCP | The backup | Backup | Backup and | Backup procedure |
| (Backup, | must follow | information | archiving | must ensure for |
| disaster | the | integrity must be | information must | accountability & |
| recovery) | confidentiality | developed for the | be available for | non-repudiation or |
| | model | backup process | restore according | use provided non- |
| | | and backed up | to the BRP | repudiation |
| | | information | | infrastructure. |

Finalizing the Calculations

By following the business process, the calculated compliance levels are modified with the information value numbers.

Example: IT Resources - Applications

| | | | | ACCOUNTABILITY/ |
|---|---|---|---|---|
| | CONFIDENTIALITY | INTEGRITY | AVAILABILITY | NON REPUDIATION |
| AUTHENTICATION | Authentication | Authentication | Authentication | Methods that |
| | information | procedures fully | procedures highly | provide for |
| | available only | protected from | available. | genuine |
| | to the security | alteration. | | authentication. |
| | management | | | |
| | team. | | | |
| ACCESS | Access control | Access control | Access control | Access control |
| CONTROL | procedures | policy consistent | infrastructure | system and |
| | tightly | throughout the | independent from | available user |
| | implemented | enterprise | the enterprise | resources provide |
| | according to | infrastructure. | infrastructure and | for accountability |
| | the predefined | | able to control any | and non- |
| | confidentiality | | resource available | repudiation. |
| | model. | | to the user. | |
| DATA | Data protection | Information | Data protection | Data protection |
| PROTECTION | based on | protection | systems | processes must |
| | classified | process must | independent from | provide for |
| | information | provide for data | database | accountability and |
| | definition | integrity. | infrastructure | non-repudiation. |
| | according to | | according to | |
| | the business | | confidentiality | |
| | information | | model. | |
| | value model. | | | |
| AUDIT | Audit trace and | Repeatable audit | Audit trace | Audit trace |
| | reports | trace and | archiving and | procedures must |
| | available to the | procedures. | availability of | provide for audit |
| | security | Consistency. | historical audits | log consistency |
| | management | | data. | and non- |
| | only. | | | repudiation. |
| ISM | Management | Management | Security | Management tools |
| (risk, policy, | procedure and | tools and | management tools | actions must |
| user) | tools available | procedures must | availability is | provide for |
| | only to | ensure that | crucial to securing | accountability and |
| | infrastructure | infrastructure | the enterprise | non-repudiation or |
| | management | changes are | infrastructure. | must integrate |
| | teams. | performed only | | with the existing |
| | | with the defined | | non-repudiation |
| | | set of tools. | | infrastructure. |
| BRP | The backup | Backup | Backup and | Backup procedure |
| (backup, | must follow | information | archiving | must ensure for |
| disaster | the | integrity must be | information must | accountability & |
| recovery) | confidentiality | developed for the | be available for | non-repudiation or |
| | model | backup process | restore according | use provided non- |
| | | and backed up | to the BRP | repudiation |
| | | information | | infrastructure. |

1. A method of increasing security in an organization, comprising the steps of
a. defining a plurality of information technology entities;
b. defining a plurality of risk and/or security components;
c. defining a plurality of security functional components; and
d. calculating a level of compliance of the organization's security components relative to a selected level of compliance.

2. A method of increasing security in an organization, comprising the steps of:
a. defining a plurality of information technology entities;
b. defining a plurality of risk and/or security components;
c. defining a plurality of security functional components; and
d. calculating a level of risk of the organization's security components relative to a selected level of risk.
